(19) United States
(12) Patent Application Publication
(10) Pub. No.: US 2008/0096754 A1
(43) Pub. Date: Apr. 24, 2008

(54) UV transmissive soda-lime-silica glass

(76) Inventors: Scott V. Thomsen, South Lyon, MI (US); Ksenia A. Landa, Brownstown, MI (US); Leonid M. Landa, Brownstown, MI (US); Richard Hulme, Rochester Hills, MI (US)

Correspondence Address: NIXON & VANDERHYE, PC, 901 NORTH GLEBE ROAD, 11TH FLOOR, ARLINGTON, VA, 22203, US

(21) Appl. No.: 11/583,135

(22) Filed: Oct. 19, 2006

(51) Int. Cl. C03C 3/11; C03C 3/078; C03C 3/087

(52) U.S. Cl. 501/56; 501/70; 501/72

(57) ABSTRACT

In certain example embodiments of this invention, an ultraviolet (UV) transmissive soda-lime-silica glass is provided. In certain example embodiments of this invention, the UV transmissive soda-lime-silica glass may be made via the float process.

Certain example embodiments of this invention relate to an ultraviolet (UV) transmissive soda-lime-silica glass. In certain example embodiments of this invention, the UV transmissive soda-lime-silica glass may be made via the float process.

### BACKGROUND AND SUMMARY OF EXAMPLE EMBODIMENTS OF THIS INVENTION

UV transmissive glasses are known. For example, U.S. Pat. No. 5,547,904 discloses a UV transmissive glass. Unfortunately, the glass of the '904 Patent is a borosilicate glass which includes a large amount of B₂O₃. Borosilicate glasses are undesirable in certain respects in that they cannot practically be made, and typically are not made, using the float process and thus require difficult and/or capital intensive manufacturing techniques. In particular, borosilicate glasses as well as fused silica are not practical for float production because of their compositions and properties (high viscosity, high cost and/or high melting temperature).

Soda-lime-silica glass is often made via the float process. For example, U.S. Pat. Nos. 7,037,869, 6,573,207, 2005/0188725, and 6,949,484 are all hereby incorporated herein by reference and all disclose example soda-lime-silica type glasses which may be made via the float process. However, typical soda-lime-silica glass has low UV transmission. For example, the examples of U.S. Pat. No. 6,949,484 have UV transmission of from about 65-77%. Such low UV transmission values are undesirable in certain situations where high UV transmissions are desired (e.g., greenhouse glazings, so-called uviol glasses, specialty optical glasses for UV lamps or the like, UV transmissive windows, etc.). In greenhouse applications, for example, UV-B (270-320 nm) transmission is desirable in order to increase plant growth. Moreover, certain UV radiation is advantageous in that it causes the human body to generate certain material (e.g., Vitamin D) that is desirable for good health. Unfortunately, heretofore, a soda-lime-silica glass has not been provided which is capable of significant UV transmission.

Additional known examples of soda-lime-silica glasses which have low UV transmission are set forth as “Standard Clear” and “ExtraClear” in FIG. 1. These two soda-lime-silica glasses in FIG. 1 have undesirably low UV transmissions of 78.5% and 82.35%, respectively, even though these glasses have relative low iron content. Moreover, these two soda-lime-silica glasses in FIG. 1 have undesirably low transmissions at 320 nm (in the UV range) of 16.10% and 20.33%, respectively.

Thus, it will be appreciated that there exists a need in the art for a soda-lime-silica based glass, optionally made via the float process, that is highly transmissive to at least some wavelength(s) of UV radiation.

In certain example embodiments of this invention, an ultraviolet (UV) transmissive soda-lime-silica based glass is provided. In certain example embodiments of this invention, the UV transmissive soda-lime-silica based glass may be made via the float process. In certain example embodiments of this invention, a soda-lime-silica glass has a UV transmission of at least 84%, more preferably of at least 86%, even more preferably of at least 88%, and most preferably of at least 90%. In certain example embodiments of this invention, a soda-lime-silica glass has a transmission at 320 nm (in the UV range) of at least 60%, more preferably of at least 65%, even more preferably of at least 70%, still more preferably of at least 75%, and possibly of at least 78%. In certain example embodiments of this invention, the soda-lime-silica glass has a visible transmission of at least about 80%, more preferably of at least about 85%, and most preferably of at least 90% or 91%. These optical characteristics may be provided at an example non-limiting reference glass thickness of about 3 mm.

In certain example embodiments of this invention, the soda-lime-silica based glass may be made using a highly reduced batch process so as to provide the glass with a high glass redox and/or a low ferric iron content. Ferric iron in significant amounts is undesirable in that it absorbs UV radiation. Thus, glasses according to certain example embodiments of this invention limit the amount of ferric (as opposed to ferrous) iron in the glass. This may be done by reducing the amount of total iron in the glass and/or by providing a high glass redox. Ferrous iron is desired over ferric iron in that ferrous iron has lower UV absorption compared to ferric iron.

In certain example embodiments of this invention, there is provided a glass comprising:

| Ingredient | wt. % |
|---|---|
| SiO₂ | 67–75% |
| Na₂O | 10–20% |
| CaO | 5–15% |

wherein the glass has a transmission at a wavelength of 3320 nm of at least about 60%, more preferably of at least about 65%, even more preferably of at least about 70%, still more preferably of at least about 75% or 78%.

### IN THE DRAWINGS

FIG. 1 is a table setting forth the chemical compositions and spectral properties of glasses according to certain example embodiments of this invention (Examples 1-3) compared to conventional “Standard Clear” and “ExtraClear” glasses.

FIG. 2 is a transmittance versus wavelength (nm) graph illustrating the difference in UV transmission between standard clear float glass and glasses of Examples 1 and 3 of the instant invention.

### DETAILED DESCRIPTION OF CERTAIN EXAMPLE EMBODIMENTS OF THIS INVENTION

In certain example embodiments of this invention, an ultraviolet (UV) transmissive soda-lime-silica based glass is provided. In certain example embodiments of this invention, the UV transmissive soda-lime-silica based glass may be made via the float process. In certain example embodiments of this invention, a soda-lime-silica based glass has a UV transmission of at least 84%, more preferably of at least 86%, even more preferably of at least 88%, and most preferably of at least 90%. In certain example embodiments of this invention, a soda-lime-silica based glass has a transmission at 320 nm (in the UV range) of at least 60%, more preferably of at least 65%, even more preferably of at least 70%, still more preferably of at least 75%, and possibly of at least 78%. In certain example embodiments of this invention, the soda-lime-silica glass has a visible transmission of at least about 80%, more preferably of at least about 85%, and most preferably of at least 90% or 91%. These optical characteristics may be provided at an example non-limiting reference glass thickness of about 3 mm.

In certain example embodiments of this invention, the glass is soda-lime-silica based and may be made via the float process, or any other suitable process such as in a patterned glass line. In addition to the base soda-lime-silica composition/glass, the soda-lime-silica based glass may also include a colorant portion. In certain example embodiments of this invention, it is desired for the glass to have a high visible transmission in combination with high UV transmission. An exemplary soda-lime-silica base glass according to certain embodiments of this invention, on a weight percentage basis, includes the following basic ingredients:

TABLE 1
EXAMPLE BASE GLASS

| Ingredient | Wt. % |
|---|---|
| SiO₂ | 67–75% |
| Na₂O | 10–20% |
| CaO | 5–15% |
| MgO | 0–7% |
| Al₂O₃ | 0–5% |
| K₂O | 0–5% |

In addition to the base glass (e.g., see Table 1 above), in making glass according to certain example embodiments of the instant invention the glass batch includes materials (including colorants and/or reducing agent(s)) which cause the resulting glass to have a reduced amount of ferric iron and/or the like, high UV transmission, high visible transmission, and/or stabilization against UV degradation. These materials may either be present in the raw materials (e.g., small amounts of iron), or may be added to the base glass materials in the batch (e.g., reducing agents). Moreover, in addition to the ingredients in Table 1 above, other minor ingredients, including various conventional refining aids, such as SO₃ and the like may also be included in the base glass. In certain embodiments, for example, glass herein may be made from batch raw materials silica sand, soda ash, dolomite, limestone, with the use of materials such as carbon, silicon, and/or the like as refining agents. In certain example embodiments, soda-lime-silica based glasses herein include by weight from about 10-15% Na₂O and from about 6-12% CaO.

Glass raw materials (e.g., silica sand, soda ash, dolomite, and/or limestone) typically include certain impurities such as iron, which is a colorant for glass. The total amount of iron present is expressed herein in terms of Fe₂O₃ in accordance with standard practice. However, typically, not all iron is in the form of Fe₂O₃. Instead, iron is usually present in both the ferrous state (Fe²⁺; expressed herein as FeO, even though all ferrous state iron in the glass may not be in the form of FeO) and the ferric state (Fe³⁺). Iron in the ferrous state (Fe²⁺; FeO) is a blue-green colorant, while iron in the ferric state (Fe³⁺) is a yellow-green colorant. The yellow-green colorant of ferric iron (Fe³+) is of particular concern when seeking to achieve a highly UV transmissive glass because ferric iron is much more of a UV absorber than is ferrous iron. Thus, high ferric iron amounts are not desirable in certain example embodiments of this invention.

In certain example embodiments of this invention, the soda-lime-silica glass is made using a reduced batch process so as to provide the glass with a high glass redox and/or a low ferric iron content. As mentioned above, ferric iron in significant amounts is undesirable in that it absorbs significant amounts of UV radiation. Thus, glasses according to certain example embodiments of this invention limit the amount of ferric iron in the glass. This may be done by reducing the amount of total iron in the glass and/or by providing a high glass redox. Because the glass may include more ferrous than ferric iron in certain example embodiments of this invention, the glass may be bluish and/or greenish in color due to the blue-green colorant nature of ferrous iron.

In certain example embodiments of this invention, the glass is essentially or substantially free of UV absorbing compounds such as ferric iron, chromium oxide, lead oxide, titanium oxide, vanadium oxide, and heavy metal sulfides. In certain example embodiments of this invention, a low total iron content glass batch is reduced so that much ferric iron is transformed into less UV absorbing ferrous iron. The reducing agents that may be used without significantly contaminating the batch are, for example and without limitation, metallic silicon, aluminum metallic, calcium silicide, silicon monoxide, tin monoxide. Optionally, though less preferred, carbon may also or instead be used as a refining aid for reducing purposes. Moreover, in certain example embodiments of this invention, the batch may be based on substantially non-oxidizing refining with sodium chloride and/or temperature in order to prevent or reduce the formation of ferric iron. In certain example embodiments, the glass may be made using a negative batch redox in order to reduce generation of significant amounts of sulfides.

In certain example embodiments of this invention, in order to improve UV transmission characteristics, the glass may contain one or more of elements such as Li, Al and/or Zn (including oxides thereof). One or more of these materials may be introduced into the batch as batch materials lithium carbonate, alumina and/or zinc oxide, respectively. The final glass may contain, for example, from 0-5% of one, two or all of lithium oxide (e.g., Li₂O), aluminum oxide (e.g., Al₂O₃), and/or zinc oxide (e.g., ZnO). The presence of one or more of these elements in the body of the glass is advantageous in that it provides a certain level of stabilization against UV degradation. The degradation effect (e.g., oxidation by UV radiation) may also or instead be reduced by heat treatment which may occur naturally or in the manufacturing process. Moreover, zinc for example may also be advantageous in that it may both cause a reducing effect and remove/reduce sulfides. For instance, zinc oxide in the glass batch may lead to substantially colorless zinc sulfide thereby preventing or reducing the generation of brown iron sulfide.

In certain example embodiments of this invention, the UV transmissive glass is achieved without the need for significant amounts of materials such as one or more of arsenic, antimony, vanadium, cerium, selenium, and lead (including oxides thereof). In certain example embodiments of this invention, the glass contains no more than 0.1%, more preferably no more than 0.05%, even more preferably no more than 0.01%, more preferably no more than about 0.005%, still more preferably no more than about 0.0005%, and possibly no more than about 0.0001% of one, two, three, four, five or all of arsenic, antimony, erbium, nickel, vanadium, cerium, selenium, and/or lead (including oxides thereof). In certain example embodiments of this invention, the glass is free of (has 0% of) one, two, three, four, five or all of arsenic, antimony, erbium, nickel, vanadium, cerium, selenium, and/or lead (including oxides thereof). In certain example embodiments, one, two, three, four, five, six, seven or all of these elements are not present even in trace amounts. As with all material percentages herein, these amounts are in terms of wt. %. Oxides as used herein include different stoichiometries; for example and without limitation the term cerium oxide as used herein includes Ce₂O₃, CeO₂, or the like, as with certain other elements mentioned herein. In certain example embodiments of this invention, the colorant portion is substantially free of colorants other than iron (other than potentially trace amounts).

It is noted that glass according to certain example embodiments of this invention is often made via the known float process in which a tin bath is utilized. It will thus be appreciated by those skilled in the art that as a result of forming the glass on molten tin in certain exemplary embodiments, small amounts of tin or tin oxide may migrate into surface areas of the glass on the side that was in contact with the tin bath during manufacture (i.e., typically, float glass may have a tin oxide concentration of 0.05% or more (wt.) in the first few microns below the surface that was in contact with the tin bath).

In view of the above, glasses according to certain example embodiments of this invention achieve high visible transmission in combination with high UV transmission. In certain embodiments, resulting glasses according to certain example embodiments of this invention may be characterized by one or more of the following transmissive optical, composition, or color characteristics (for the optics, an example non-limiting reference thickness of about 3 mm is used). Note that Lta is visible transmission %, and % T is percent transmission at 320 nm which is in the UV range.

TABLE 2
GLASS CHARACTERISTICS OF EXAMPLE EMBODIMENTS

| Character- | | | |
|---|---|---|---|
| istic | General | More Preferred | Most Preferred |
| Lta | >=80% | >=85% | >=90% or 91% |
| (Lt D65): | | | |
| % UV | >=84% | >=86% | >=88% or 90% |
| (300–400 | | | |
| nm): | | | |
| % T at | >=60% | >=65% | >=70%, 75% or 78% |
| 320 nm: | | | |
| total iron | <=0.15% | 0.001–0.10% | 0.005–0.05% |
| (Fe₂O₃): | | | |
| % FeO: | 0.001–0.02% | 0.002–0.01% | 0.004–0.008% |
| Glass Redox: | >=0.3 | >=0.35 | >=0.4, 0.5 or 0.55 |
| zinc oxide: | 0–5% | 0.1–3.0% | 0.5–2.0% |
| lithium | 0–5% | 0.1–3.0% | 0.5–2.0% |
| oxide: | | | |
| aluminum | 0–5% | 0.75–2.5% | 1.0–2.0% |
| oxide: | | | |
| Cl: | 0–5% | 0.1–2.0% | 0.25–1.0% |
| SO₃ | <=0.1 or 0.05% | 0.0001–0.05% | 0.0001–0.02% |

As can be seen from Table 2 above, glasses of certain embodiments of this invention achieve desired features of high visible transmission and/or high UV transmission.

### EXAMPLES 1-3

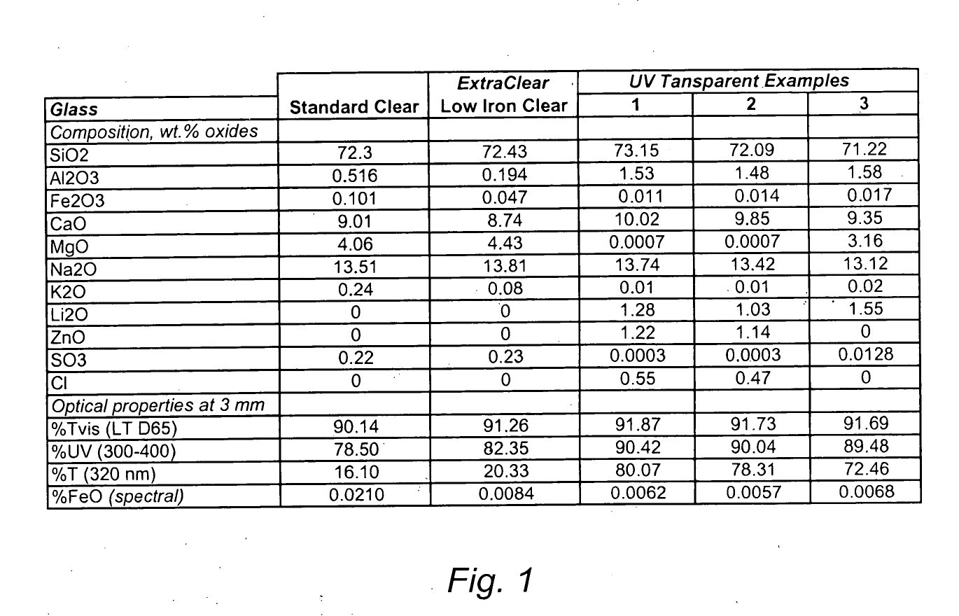

Example glasses were made and tested according to example embodiments of this invention, as shown in FIG. 1. In particular, the three right-most columns in FIG. 1 illustrate the respective compositions and optical characteristics of the glasses of Examples 1-3 of this invention. For purposes of comparison, conventional “Standard Clear” and “ExtraClear” glasses and their characteristics are also provided at the left-hand portion of FIG. 1. It can be seen from FIG. 1 that the Examples of this invention had higher UV transmission compared to the conventional “Regular clear” and “ExtraClear” glasses. In this regard, note the reduction in SO₃ in the Examples 1-3 compared to the conventional glasses, which indicates the presence of less oxidizers in the batch and a lower batch redox, and thus lower ferric iron content compared to ferrous iron content. Note also the presence of zinc oxide and/or lithium oxide in the glasses of Examples 1-3, for improvement of such UV transmission characteristics. It is also noted, for example, that Example 1 for instance has a total iron content of 0.011% and an FeO content of 0.0062, and thus a glass redox of 0.56.

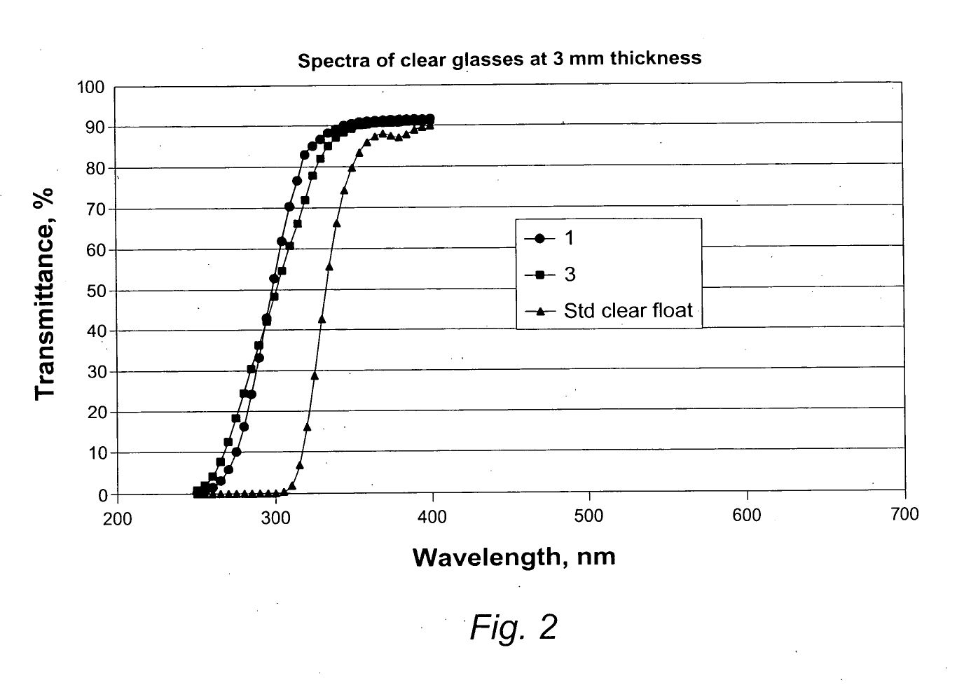

FIG. 2 is a transmittance versus wavelength (nm) graph illustrating the difference in UV transmission between standard clear float glass and glasses of Examples 1 and 3.

It is noted that the term UV transmission is well known in the art. UV transmission may, for example, be calculated using Parry Moon Air Mass=2 (300-400 nm inclusive, integrated using Simpson's Rule at 10 nm intervals), or via any other suitable technique for this range.

Once given the above disclosure many other features, modifications and improvements will become apparent to the skilled artisan. Such features, modifications and improvements are therefore considered to be a part of this invention, the scope of which is to be determined by the following claims:

What is claimed is:

1. Glass comprising:

| Ingredient | wt. % |
|---|---|
| SiO₂ | 67–75% |
| Na₂O | 10–20% |
| CaO | 5–15% |

wherein the glass has a transmission at a wavelength of 320 nm of at least about 60%.

2. The glass of claim 1, wherein the glass has a transmission at a wavelength of 320 nm of at least about 65%.

3. The glass of claim 1, wherein the glass has a transmission at a wavelength of 320 nm of at least about 70%.

4. The glass of claim 1, wherein the glass has a transmission at a wavelength of 320 nm of at least about 75%.

5. The glass of claim 1, wherein the glass has a transmission at a wavelength of 320 nm of at least about 78%.

6. The glass of claim 1, wherein the glass has a total iron (expressed as Fe₂O₃) content of less than or equal to 0.15%.

7. The glass of claim 1, wherein the glass has a total iron (expressed as Fe₂O₃) content of from 0.001 to 0.10%.

8. The glass of claim 1, wherein the glass comprises from 0-0.05% SO₃.

9. The glass of claim 1, wherein the glass comprises from 0-0.02% SO₃.

10. The glass of claim 1, wherein the glass has a visible transmission of at least about 85%.

11. The glass of claim 1, wherein the glass has a visible transmission of at least about 90%.

12. The glass of claim 1, wherein the glass comprises from 0 to 5% of each of zinc oxide, lithium oxide and aluminum oxide.

13. The glass of claim 1, wherein the glass comprises from 0.1 to 3.0% zinc oxide.

14. The glass of claim 1, wherein the glass comprises from 0.1 to 3.0% lithium oxide.

15. The glass of claim 1, wherein the glass comprises from about 0.1 to 2.0% Cl.

16. The glass of claim 1, wherein the glass has a glass redox of at least 0.4.

17. The glass of claim 1, wherein the glass has a glass redox of at least 0.5.

18. The glass of claim 1, wherein the glass has a glass redox of at least 0.55.

19. The glass of claim 1, wherein the glass has a UV transmission (300-400 nm) of at least 84%.

20. The glass of claim 1, wherein the glass has a UV transmission (300-400 nm) of at least 86%.

21. The glass of claim 1, wherein the glass has a UV transmission (300-400 nm) of at least 88%.

22. The glass of claim 1, wherein the glass has a UV transmission (300-400 nm) of at least 90%.

23. The glass of claim 1, wherein the glass is substantially free of cerium oxide.

24. The glass of claim 1, wherein the glass is substantially free of vanadium oxide.

25. The glass of claim 1, wherein the glass is substantially free of lead oxide.

26. The glass of claim 1, wherein the glass is substantially free of each of cerium oxide, vanadium oxide, lead oxide, nickel, selenium and arsenic.

27. The glass of claim 1, wherein the glass is made via a float process so that tin and/or tin oxide from a tin bath is provided at a surface area of the glass.
